(19) United States
(12) Patent Application Publication
(10) Pub. No.: US 2026/0338578 A1
(43) Pub. Date: Oct. 29, 2026

(54) ORTHOPHOTO SEGMENTATION

(71) Applicant: HONDA MOTOR CO., LTD., Tokyo (JP)

(72) Inventors: Tyler NAES, San Jose, CA (US); Xiaoshan LIN, Menlo Park, CA (US)

(21) Appl. No.: 19/655,810

(22) Filed: Apr. 23, 2026

Related U.S. Application Data
(60) Provisional application No. 63/794,070, filed on Apr. 24, 2025.

(51) Int. Cl. G01C 21/00; G06T 3/4038; G06T 7/11

(52) U.S. Cl. CPC G01C 21/3826; G06T 3/4038; G06T 7/11; G06T 2207/10032; G06T 2207/20132; G06T 2207/20212; G06T 2207/30181

(57) ABSTRACT

According to one aspect, orthophoto segmentation may include cropping an orthophoto into a set of segments, segmenting each segment of the set of segments using a segmentation model to generate a set of segmentation masks for each segment of the set of segments, and unionizing segments that are neighboring segments from the set of segments based on the set of segmentation masks for each segment to generate a finely segmented (FS) terrain map. A first segment of the set of segments may partially overlap a second segment of the set of segments. Orthophoto segmentation may also include generating a coarsely-segmented (CS) terrain map without cropping the orthophoto based on a second segmentation model, generating a combined terrain map based on the FS terrain map and the CS terrain map, assigning a cost to each segmentation mask of the combined terrain map, and performing path planning for a vehicle based on the combined terrain map.

### CROSS-REFERENCE TO RELATED APPLICATIONS

This application claims the benefit of U.S. Provisional Patent Application, Ser. No. 63/794,070 (Attorney Docket No. H1251249US01) entitled “DRONE SEGMENTATION”, filed on Apr. 24, 2025; the entirety of the above-noted application(s) is incorporated by reference herein.

### BACKGROUND

An orthophoto or orthoimage may be a geometrically corrected aerial photograph that combines the detailed visual information of a photo with the accurate, uniform scale of a map. By removing distortions from camera tilt and terrain relief, orthophotos allow direct, precise measurements of distances, angles, and areas. Some challenges that often arise involve geometric distortions, such as building lean (e.g., radial displacement) and bridge distortion, caused by using Digital Terrain Models (DTMs) that lack elevated feature data. Other issues include high production costs, low-quality imagery (e.g., blur, shadows), and significant data management issues with large files.

Image segmentation in computer vision is the process of partitioning an image into multiple, distinct regions or segments at the pixel level to identify objects and boundaries. Image segmentation may enhance image understanding for tasks like autonomous driving, medical imaging (e.g., tumor detection), and robotic vision by providing precise object localization. While image segmentation may be performed orthophotos, challenges may exist, such as a high annotation cost, difficulty defining complex boundaries, occlusion, generalization errors, computational cost, etc.

### BRIEF DESCRIPTION

According to one aspect, a system for orthophoto segmentation may include a processor and a memory. The memory may store one or more instructions. The processor may execute one or more of the instructions stored on the memory to perform one or more acts, actions, and/or steps. The processor may perform cropping an orthophoto into a set of segments. The processor may perform segmenting each segment of the set of segments using a segmentation model to generate a set of segmentation masks for each segment of the set of segments. The processor may perform unionizing segments that are neighboring segments from the set of segments based on the set of segmentation masks for each segment to generate a finely-segmented (FS) terrain map.

A first segment of the set of segments may at least partially overlap a second segment of the set of segments. The processor may generate a coarsely-segmented (CS) terrain map without cropping the orthophoto based on a second segmentation model. The processor may generate a combined terrain map based on the FS terrain map and the CS terrain map. The processor may assign a cost to each segmentation mask of the combined terrain map. The processor may perform path planning for a vehicle based on the combined terrain map. The processor may identify one or more objects from the FS terrain map using on a neural network. The processor may perform unionizing the segments based on an intersection of union (IoU) of the set of segmentation masks for each segment. The processor may perform unionizing the segments based on a maximum intersection of union (IoM) of the set of segmentation masks for each segment. The segmentation model used to segment each segment of the set of segments may be a Segment Anything Model (SAM).

According to one aspect, a computer-implemented method for orthophoto segmentation may include cropping an orthophoto into a set of segments, segmenting each segment of the set of segments using a segmentation model to generate a set of segmentation masks for each segment of the set of segments, and unionizing segments that are neighboring segments from the set of segments based on the set of segmentation masks for each segment to generate a finely segmented (FS) terrain map.

A first segment of the set of segments may at least partially overlap a second segment of the set of segments. The computer-implemented method for orthophoto segmentation may include generating a coarsely-segmented (CS) terrain map without cropping the orthophoto based on a second segmentation model, generating a combined terrain map based on the FS terrain map and the CS terrain map, assigning a cost to each segmentation mask of the combined terrain map, and performing path planning for a vehicle based on the combined terrain map. The computer-implemented method for orthophoto segmentation may include identifying one or more objects from the FS terrain map using on a neural network. The unionizing of the segments may be based on an intersection of union (IoU) and a maximum intersection of union (IoM) of the set of segmentation masks for each segment. The segmentation model used to segment each segment of the set of segments may be a Segment Anything Model (SAM).

According to one aspect, a system for orthophoto segmentation may include a processor and a memory. The memory may store one or more instructions. The processor may execute one or more of the instructions stored on the memory to perform one or more acts, actions, and/or steps. The processor may perform cropping an orthophoto into a set of segments. The processor may perform segmenting each segment of the set of segments using a segmentation model to generate a set of segmentation masks for each segment of the set of segments. The processor may perform unionizing segments that are neighboring segments from the set of segments based on the set of segmentation masks for each segment. The processor may perform generating a finely segmented (FS) terrain map based on the unionized segments.

### BRIEF DESCRIPTION OF THE DRAWINGS

FIG. 1 is an exemplary component diagram of a system for orthophoto segmentation, according to one aspect.

FIG. 2 is an exemplary flow diagram of a computer-implemented method for orthophoto segmentation, according to one aspect.

FIG. 3 is an exemplary illustration of cropping an orthophoto into a set of segments in association with orthophoto segmentation, according to one aspect.

FIG. 4 is an exemplary illustration of segmenting and unionizing segments of an orthophoto in association with orthophoto segmentation, according to one aspect.

FIG. 5 is an exemplary flow diagram of a computer-implemented for orthophoto segmentation, according to one aspect.

FIG. 6 is an exemplary flow diagram of a computer-implemented for path planning using orthophoto segmentation, according to one aspect.

FIG. 7 is an illustration of an example computing environment where one or more of the provisions set forth herein are implemented, according to one aspect.

FIG. 8 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “controller”, as used herein, may be a device implemented in hardware, firmware, software, or a combination thereof. A controller may include one or more CPUs (e.g., a central processing unit including one or more “processors”), a “memory”, a “storage drive”, a “bus”, and one or more programmable input/output (I/O) peripherals.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system”, as used herein, may be any automatic or manual systems that may be used to enhance the vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

Traditional robotics excels in structured settings where every landmark and region is pre-labeled. In contrast, real-world field operations demand systems that infer semantic structure on demand. Vision Language Models (VLMs) may assign labels to previously unseen classes and interpret scene context, extending the concept of open-vocabulary detection. Yet, aerial imagery poses unique challenges due to viewpoint and scale differences, and VLMs may address this effectively.

Terrain classification further enhances planning by encoding surface slope, roughness, and traversability. Incorporating these cues into optimization-based planners yields more efficient routes. However, unmanned ground vehicles (UGVs) relying solely on onboard perception risk may encounter dead ends due to limited local visibility. Aerial imagery offers global situational awareness but often at a low spatial resolution due to limited Ground Sample Distance (GSD), leading others to rely on coarse binary labels.

High-resolution maps may be prepared in advance; however, construction sites evolve rapidly, rendering static maps obsolete. Multi-agent approaches may maintain updated terrain maps, but these depend on dense agent coverage. However, by utilizing the perceiving capabilities of a drone, a UAV-UGV team may efficiently handle the terrain mapping for the UGV navigation.

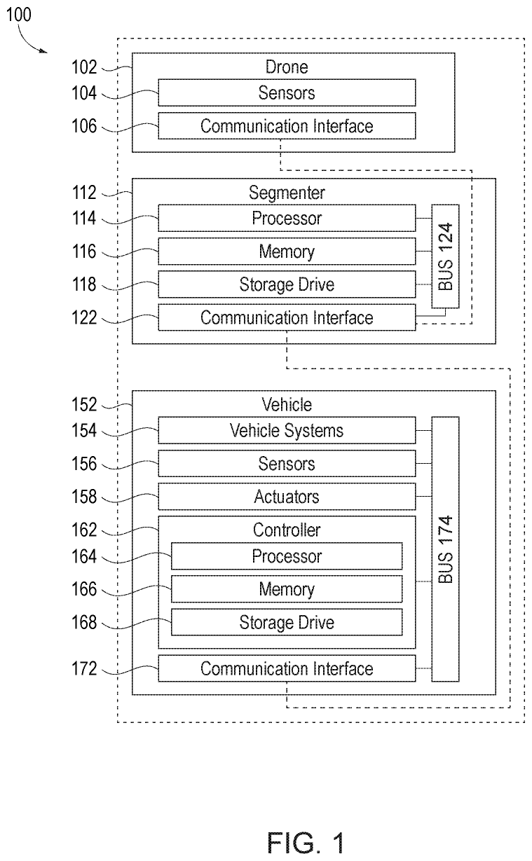

FIG. 1 is an exemplary component diagram of a system 100 for orthophoto segmentation, according to one aspect. The system 100 for orthophoto segmentation may include a drone 102 that performs data collection and facilitates orthophoto generation. The drone 102 may be equipped with sensors 104 and a communication interface 106. The drone 102 may be an aerial drone flown over a target area that will be used for creating an orthophoto and the sensors 104 may be image capture sensors that may capture an aerial image. The aerial image may be processed to generate the orthophoto. According to one aspect, the processing may happen aboard the drone 102 or may occur off-board the drone 102. In any event, the communication interface 106 may transmit the aerial image to another device. For example, the communication interface 106 of the drone 102 may transmit the aerial image to a segmenter.

According to one aspect, orthophotos may utilize aerial images (e.g., from a birds-eye-view perspective) with GPS coordinates of the drone 102's location when the images are taken. The aerial images may have some overlap with their neighboring images in order to stitch them together to generate the single, large, orthophoto. The images in the system 100 for orthophoto segmentation may be taken, for example, with 85% overlap between each image and the cm-level GPS coordinates for each image may be recorded. The orthophoto may be generated, for example, using OpenDrone 102Map (ODM) and the aerial images that were collected by the drone 102. Before using ODM, the images may be reformatted to embed the images with their respective GPS coordinates. The orthophoto may be a large, single image that has GPS coordinates embedded in each pixel of the image. This enables use as a map for the UGV by providing the UGV with a list of GPS waypoints that may be extracted from the orthophoto.

The segmenter 112 may include a processor 114, a memory 116, a storage drive 118, a communication interface 122, a bus 124, etc. The communication interface 106 of the drone 102 may transmit the aerial image to the communication interface 122 of the segmenter 112. The communication interface 122 may pass the aerial image via the bus 124 to the storage drive 118. Thereafter, the processor 114 may process the aerial image to generate an orthophoto. The orthophoto may be stored on the storage drive 118. Additionally, the memory 116 may store one or more instructions. The processor 114 may execute one or more of the instructions stored on the memory 116 to perform one or more acts, actions, and/or steps.

### Neighboring Image-Cropped Unionization-Segment Anything Model (NICU-SAM)

To improve SAM's performance on large and information-dense images, the system 100 for orthophoto segmentation may implement a pre and post processing technique called Neighboring Image-Cropped Unionization (NICU) for SAM (NICU-SAM). Pre-processing may start with cropping the ODM-generated orthophoto into smaller equally sized segments of the entire orthophoto. These cropped segments share a small percentage of overlap with their neighboring segments (e.g., 20% of overlap on each edge of the segments).

In this regard, the processor 114 may perform cropping an orthophoto into a set of segments. A first segment of the set of segments may at least partially overlap a second segment of the set of segments. The processor 114 may perform segmenting each segment of the set of segments using a first segmentation model to generate a set of segmentation masks for each segment of the set of segments. According to one aspect, the segmentation model (e.g., the first segmentation model) used to segment each segment of the set of segments may be a Segment Anything Model (SAM).

The SAM is a segmentation model that is capable of segmenting everything in an image with a high degree of accuracy and image coverage. However, SAM was mainly trained using images taken from ground-level perspectives and was not necessarily intended for remote-sensing applications. The segmentation of the ODM-generated orthophoto serves as a benchmark to compare against the NICU-SAM technique in the system 100 for orthophoto segmentation.

The cropped segments may be fed into SAM individually by the processor 114 for segmentation. Due to the reduction in image size compared to the original orthophoto, a much higher density of individual segmentations may be achieved compared to a baseline orthophoto segmentation. One post-processing objective may be to stitch the individual image-cropped segmentations back together while unionizing border segmentations with their respective neighbors.

The processor 114 may perform unionizing segments that are neighboring segments from the set of segments based on the set of segmentation masks for each segment to generate a finely-segmented (FS) terrain map. In this way, the processor 114 may perform generating a finely segmented orthophoto based on the unionized segments. According to one aspect, the processor 114 may perform unionizing the segments based on an intersection of union (IoU) of the set of segmentation masks for each segment and/or a maximum intersection of union (IoM) of the set of segmentation masks for each segment. In this way, a remote-sensing-adapted segmentation model may enhance aerial labeling.

The unionization of neighboring border segments is performed by overlaying the overlap regions of two neighboring segments on top of each other. The segmentation masks from both cropped segments inside this overlap region may be analyzed by the processor 114 to determine which, if any, border segmentations need to be unionized when stitching the cropped segments back together. This determination is made by first finding the IoU, (1), of the segmentation masks as a whole and then finding the IoM, (2) for each individual cropped segments.

$$IoU = \frac{{px}_{green}}{{px}_{green} + {px}_{blue} + {px}_{red}} \qquad ( 1 )$$

$$IoM = max ( \frac{{px}_{green}}{{px}_{green} + {px}_{blue}} , \frac{{px}_{green}}{{px}_{green} + {px}_{red}} ) \qquad ( 2 )$$

px may represent the total pixel count for the respective masks,
px_{green} may represent overlapping segmentation masks between a first segment and a second segment
px_{red} may represent a segmentation mask from a first segment, and
px_{blue} may represent a segmentation mask from a second segment that is a segment neighboring the first segment.

If both IoU and IoM are greater than a predetermined threshold values (e.g., an IoU threshold and an IoM threshold), then the segmentation masks may be unionized when stitched back together. According to one aspect, the IoU threshold value may be set to be 0.9 and IoM threshold may be set to be 0.85, for example.

The processor 114 may generate a coarsely-segmented (CS) terrain map without cropping the orthophoto based on a second segmentation model (e.g., a SegEarth-OV (open-vocabulary) model). For example, SegEarth-OV is an open-vocabulary semantic segmentation model for aerial images that creates segmentations based on user-provided labels. An LLM, such as Chat-GPT may be used to create the list of labels for SegEarth-OV by asking it what various terrain types and man-made infrastructure one would typically find on an agricultural farm (e.g., the scene used GRID during data collection). The output list of labels may be fed to the SegEarth-OV model along with the orthophoto obtained from ODM. SegEarth-OV may then output the CS terrain map of the orthophoto. One advantage or benefit provided herein is the ability to improve SegEarth-OV's segmentation performance; by combining the terrain labels generated for the CS terrain map's segmentations with the segmentation accuracy from SAM, a finely-segmented terrain map (FS terrain map) may be possible.

The processor 114 may generate a combined terrain map based on the FS terrain map and the CS terrain map. The processor 114 may assign a cost to each segmentation mask of the combined terrain map. The processor 114 may create a cost map for the path planner and perform semantic segmentation of the orthophoto using the SegEarth-OV model to differentiate and localize the various terrain types in the orthophoto. The terrain types may be assigned predetermined costs associated therewith that may be referenced during path planning. As used herein, the term or phrase ‘terrain’ in the system 100 for orthophoto segmentation is not limited to naturally occurring & traversable areas. ‘Terrain’ may also include man-made assets or features (e.g., roads, sidewalks, dirt paths, etc.) as well as vertical structures (e.g., buildings, fences, etc.).

The FS terrain map utilized for the UGV path planning may be obtained or generated by combining the semantic terrain information from the CS terrain map with the segmentation masks from the NICU-SAM technique into a cost-imposable map (e.g., cost map or combined terrain map) overlaying the ODM-generated orthophoto. This combined terrain map allows extraction of the GPS coordinates and a corresponding cost for every pixel of the FS terrain map. The cost-imposable terrain label may be applied to the NICU-SAM segmentation masks by referencing every pixel inside those masks with the CS terrain map's semantic segmentations. For each individual NICU-SAM segmentation mask, the processor 114 may tally every pixel's terrain label. The terrain label that has the highest pixel count may be applied to the NICU-SAM segmentation masks in the FS terrain map. However, there are instances where multiple labels have relatively a high pixel count for a certain NICU-SAM mask. For this, set a predetermined percentage threshold that differentiates a confident terrain label and a possible terrain label.

Thus, the FS terrain map may be utilized to generate a cost map that is GPS-embedded with various terrain types and impassable structures that a GPS-equipped UGV may use for point-to-point reiterative planning. Assigning terrain costs may be based on the traversing capabilities of the UGV. Any terrain that the UGV is capable of traversing may be assigned a cost that is representative of how ideal that terrain is for the UGV to traverse thereacross. Any untraversable terrains may be assigned an infinite cost. The same is true for any impassible structures on the FS terrain map. For the system 100 for orthophoto segmentation, the D* algorithm may be utilized for real-time planning of a UGV that is initialized at a predetermined location in the FS terrain map. The goal location is determined by an LLM that takes a human-provided command dictating where the UGV may reach the end goal.

### Open-Vocabulary Object Detection

The processor 114 may identify one or more objects from the FS terrain map using on a neural network. For example, large language model (LLM) based generation of task-relevant semantic classes from natural-language commands may be performed by the processor 114. According to one aspect, the processor 114 may run an open-vocabulary object detection model on the FS terrain map for generating list of localized objects to act as goal locations. The LLM may be stored on the storage drive 118 or accessed via the communication interface 122.

At this point, the vehicle or UGV may have the cost map of its environment that it may use for path planning when given GPS coordinates of a goal to where it should navigate. If the UGV is capable of also detecting and labeling objects in the FS terrain map, then the UGV may use the contextual reasoning capabilities of an LLM to determine its goal when given a verbal command from a human on where it should go. The system 100 for orthophoto segmentation investigated the performance of using a Recognize Anything Model (RAM) to perform object detection and labeling on the FS terrain map to create a query of objects in the FS-map that the UGV is able to use as possible goal locations.

Because the objects may be localized on the FS terrain map, their GPS coordinates may be extracted and fed to the UGV for its D* path planning. The issue with object detection in aerial images is that ground truth labeled datasets for remote sensing applications may be limited. Training a BEV object detection model would have a limited scope of objects classes that it may handle. It was determined that open-vocabulary object detection models trained on images from an on-the-ground perspective perform poorly on aerial imagery and is discussed more in detail in the results and conclusion section of this paper. The system 100 for orthophoto segmentation may instead create ground truth labels for various objects in the FS terrain map for the LLM to reference when determining the goal location for the UGV.

### Human Language Goal Specification and VLM Reasoning

The processor 114 may determine an end goal or target location based on a user command using contextual reasoning of the LLM. The processor 114 may perform path planning for a vehicle based on the combined terrain map and generate a path plan including a set of waypoints from the vehicle (e.g., the UGV) to the end goal on the FS terrain map using a D* algorithm or modified D* algorithm.

A UGV that may determine the goal position on the FS terrain map based on human natural language instruction is beneficial in terms of autonomy. This would require a human to only give a brief description of the location that the human desires the UGV to navigate to, and the UGV will handle the rest. Sometimes, there may be multiple objects in the FS terrain map that fit a description provided by a human which may lead to the UGV choosing the incorrect goal location. Humans naturally understand that providing context when giving directions to someone may help ensure that the person will find their desired goal/destination. For example, one might say “It's the third house on the left” or “Go to the building with the red roof” when giving directions. This same contextual information may be fed to a LLM to assist the UGV in finding the correct goal on the FS terrain map.

According to one aspect, the system 100 for orthophoto segmentation may include the vehicle 152 (e.g., UGV). The vehicle may include one or more vehicle systems 154, one or more sensors 156, one or more actuators 158, and a controller 162. The controller may include a processor 164, a memory 166, and a storage drive 168. The vehicle may include a communication interface 172 and a bus 174. The communication interface 172 may receive the combined terrain map, a cost map associated with the combined terrain map, path planning signals, etc. from the segmenter 112. According to one aspect, the path planning may be performed external to the vehicle 152. According to another aspect, the path planning may be performed on board the vehicle 152. In any event, the combined terrain map, the costs associated with the combined terrain map, one or more of the objects identified from the FS terrain map, etc. may be utilized to facilitate the path planning for the vehicle 152. The path planning may be implemented via the vehicle systems 154 and the actuators 158 to move the vehicle 152 from waypoint to waypoint.

The advantage of path planning for UGVs in unconstrained environments may thus be provided based on the combined terrain map. This may be accomplished by pairing an unmanned aerial vehicle (UAV), such as the drone 102, with natural language spatial constraints. The UAV or drone 102 may acquire images or aerial images to build the orthophoto, which may be segmented via a two-stage scheme: (i) SegEarth-OV may yield a coarse terrain map that is (ii) refined with the Segment Anything Model (SAM). Larger images may be handled using Neighboring Image-Cropped Unionization-Segment Anything Model (NICU-SAM). The resulting FS terrain map (FS-map) may thus support direct extractions of GPS waypoints. Any LLM may convert terrain types and constraints into heuristic costs with which the D* algorithm may plan maneuvers for the UGVs. Additionally, the LLM may convert a user-language request to determine a goal waypoint. It has been shown that open-vocabulary (OV) segmentation models trained on ground-level views degrade on bird's-eye images, thus motivating remote sensing-oriented counterparts for aerial-ground applications.

### Re-Planning or Updated Planning Based on Local Perception

The UGV may reach its target destination using only the FS terrain map and the D* path planning algorithm. The D* path planning algorithm allows robots or autonomous vehicles to update the map of its environment using on-board sensors 156 which may provide real-time sensor data feedback for map updating. According to one aspect, updating the FS terrain map using on-board sensor data may be performed by the vehicle 152. Thus, the sensors 156 of the vehicle 152 may detect one or more objects or obstacles.

According to another aspect, the processor 164 of the vehicle 152 may create a ground truth map of the environment that the UGV may use to act as its perception system for map updating. This may be accomplished by setting a predetermined ‘perception radius’ for the UGV that limits how much of FS terrain map in the UGV's current vicinity that may be updated from the ground truth map. For the system 100 for orthophoto segmentation set this perception radius to be. As a UGV navigates using the FS terrain map, it would update the cost map within perception radius with the ground truth map and replan accordingly. The UGV may make adjustments via the controller 162, the processor 164, the memory 166, and the storage drive 168 to its path plan as the FS terrain map is updated with ground truth information during navigation. The updated ground truth map may be stored on the storage drive 168 and/or communicated back to the segmenter 112 via the communication interface.

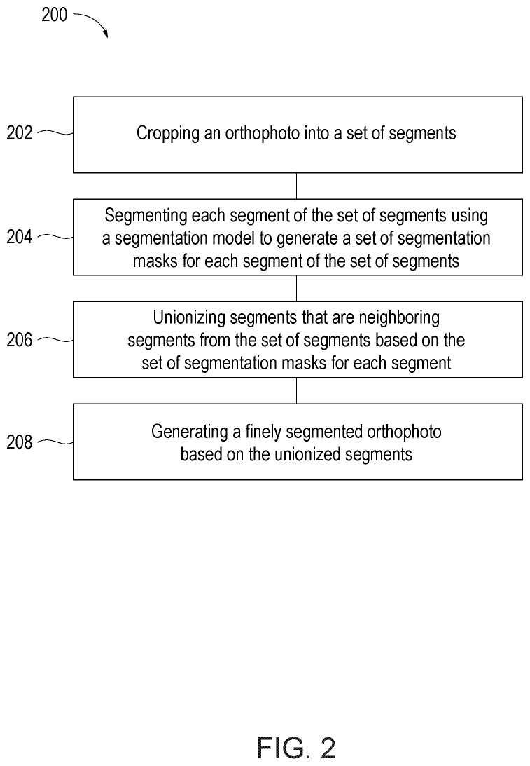

FIG. 2 is an exemplary flow diagram of a computer-implemented method 200 for orthophoto segmentation, according to one aspect. The computer-implemented method 200 for orthophoto segmentation may include cropping 202 an orthophoto into a set of segments, segmenting 204 each segment of the set of segments using a segmentation model to generate a set of segmentation masks for each segment of the set of segments, unionizing 206 segments that are neighboring segments from the set of segments based on the set of segmentation masks for each segment, and generating 208 a finely segmented (FS) terrain map.

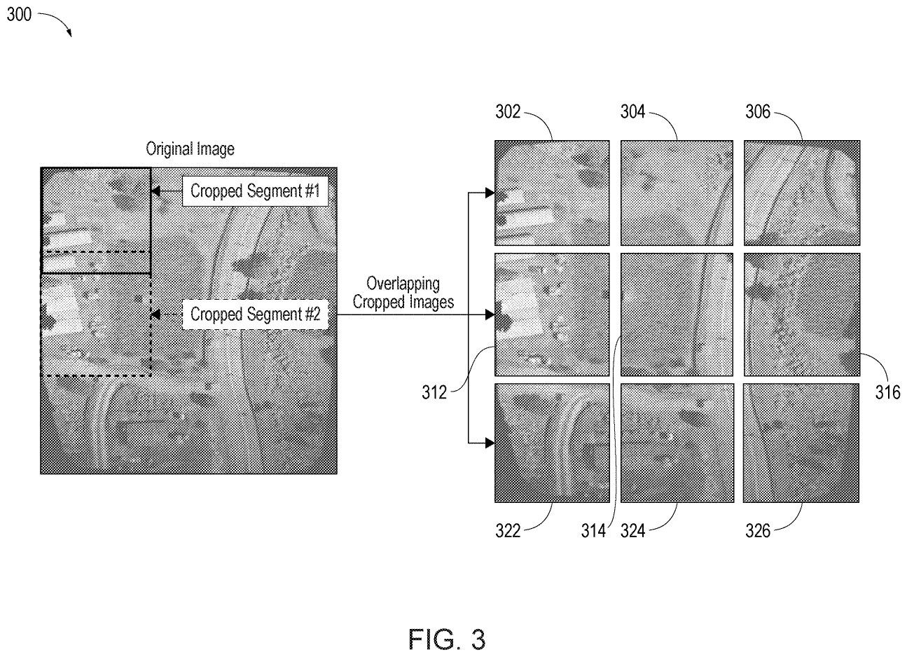

FIG. 3 is an exemplary illustration of cropping an orthophoto 300 into a set of segments 302, 304, 306, 312, 314, 316, 322, 324, 326, in association with orthophoto segmentation, according to one aspect. An example of this cropping procedure may be visualized in FIG. 3. An overlap (e.g., shown on the left) may be utilized for the post-processing operations. Due to orthophotos typically having an irregular shape and size, the processor may create the cropped segments from the center of the orthophoto and expanded outwards. While the cropped segments from the edge of the orthophoto will have some white space in their cropped segments, post-processing operations may handle this white space of missing image data.

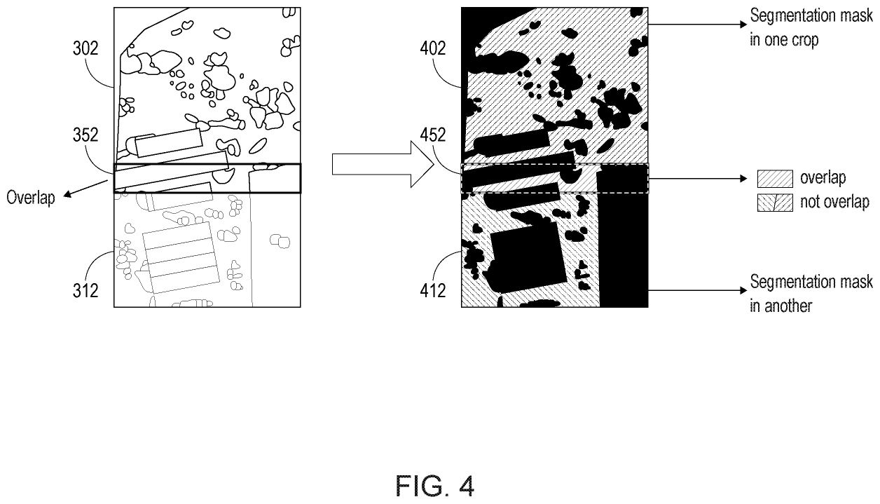

FIG. 4 is an exemplary illustration of segmenting and unionizing segments of an orthophoto in association with orthophoto segmentation, according to one aspect. FIG. 4 provides an example of two neighboring cropped segments. A first cropped segment 302 and a second cropped segment 312 may have an overlap 352, which may be a predefined amount of overlap. Each of the first cropped segment 302 and the second cropped segment 312 may be fed through a segmentation model (e.g., SAM) and segmentation masks may be generated. For example, a first segmentation mask 402 may be generated for the first cropped segment 302 and a second segmentation mask 412 may be generated for the second cropped segment 312. Unionization may be applied using NICU-SAM for the overlapping mask segments 452.

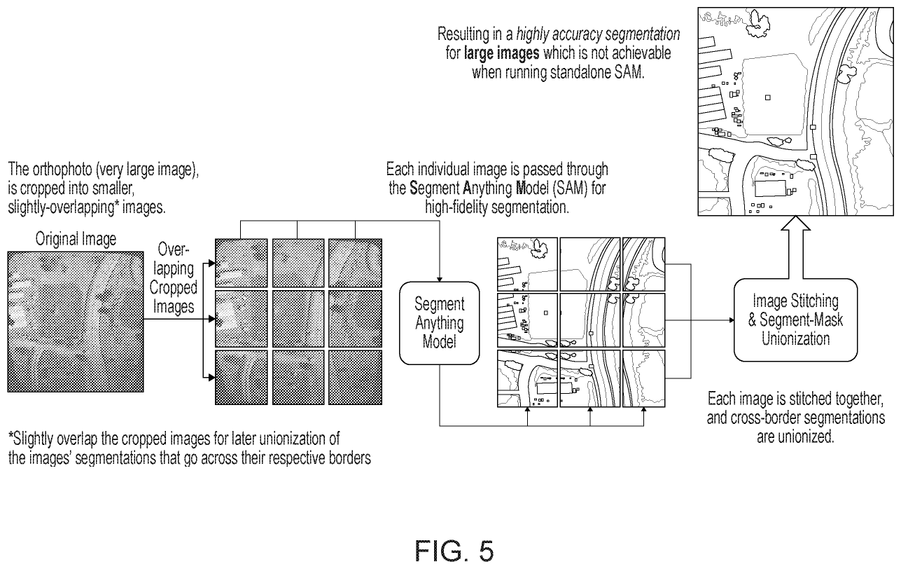

FIG. 5 is an exemplary flow diagram of a computer-implemented for orthophoto segmentation, according to one aspect. This process of analyzing border segmentation masks of neighboring segments may be performed on every combination of neighboring pairs of cropped segments horizontally (e.g., for left and right borders) and then vertically (e.g., for top and bottom borders). The final result of the NICU-SAM technique was obtained by taking the cropped segments, removing the no longer needed overlap area, tiling them back together, and unionizing the border segmentation masks that met the IOU and IOM threshold qualifications, as shown in FIG. 5.

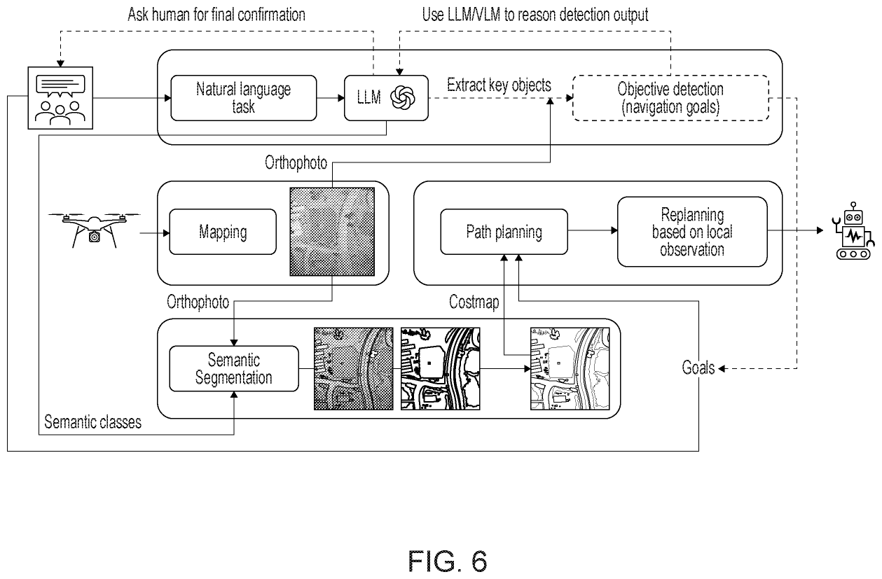

FIG. 6 is an exemplary flow diagram of a computer-implemented for path planning using orthophoto segmentation, according to one aspect. The pipeline of FIG. 6 integrates drone perception with LLMs and VLMs reasoning to generate global navigation plans for UGVs that are terrain aware via aerial perception in unstructured environments. A natural-language task may be parsed by the LLM to extract objectives and identify relevant targets. Simultaneously or concurrently, the drone may capture an aerial map of the environment and generate a corresponding orthophoto. The LLM/VLM may provide semantic labels for the orthophoto or map, identifying terrain, obstacles, and targets. These semantic labels may be used to segment the scene, estimate traversability, and produce a global plan for the UGV.

The approach shown in FIG. 6 includes (i) generating an open-set, geo-referenced terrain maps from UAV orthophotos; (ii) translating natural-language spatial directives into terrain-dependent costs using vision-language models with minimal human supervision; and (iii) applying grid-based D* planning to produce GPS-referenced routes. This closes the loop from overhead images and language to actionable UGV routes in unconstrained environments.

Thus, the UAV-UGV pipeline for long-horizon navigation in unconstrained environments that converts UAV orthophotos into an open-set, geo-referenced terrain map and plans UGV waypoints using the D* algorithm under natural-language constraints may be provided herein. Two-stage segmentation (e.g., SegEarth-OV followed by NICU-SAM) may produce the FS terrain map from which GPS waypoints may be extracted. In this way, the system may yield feasible, cost-aware routes aligned with user directives. Again, OV models trained on ground-level views degrade on bird's-eye imagery, underscoring the need for remote-sensing-oriented counterparts.

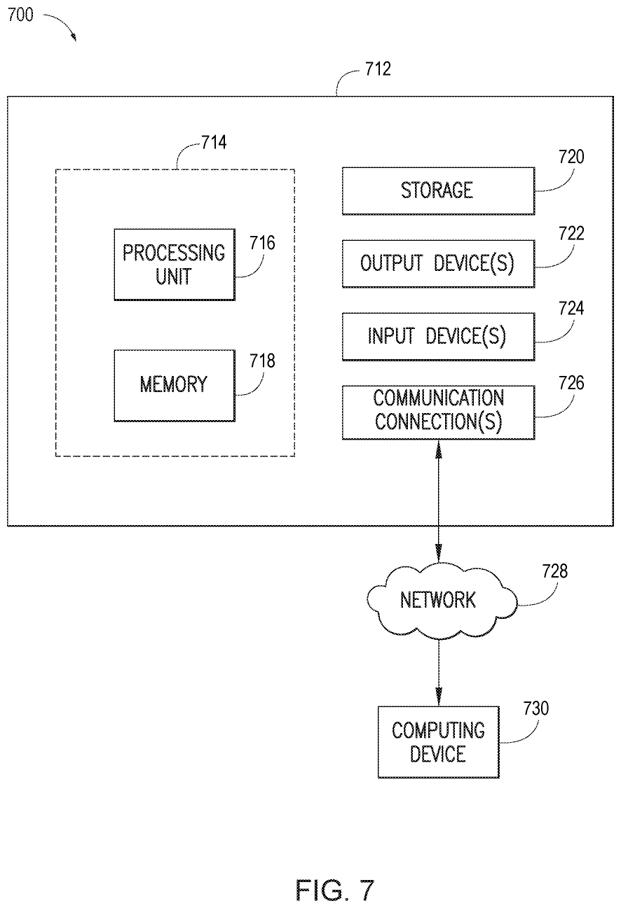

FIG. 7 and the following discussion provide a description of a suitable computing environment to implement aspects of one or more of the provisions set forth herein. The operating environment of FIG. 7 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini-computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 7 illustrates a system 700 including a computing device 712 configured to implement one aspect provided herein. In one configuration, the computing device 712 includes at least one processing unit 716 and memory 718. Depending on the exact configuration and type of computing device, memory 718 may be volatile, such as RAM, non-volatile, such as ROM, flash memory, etc., or a combination of the two. This configuration is illustrated in FIG. 7 by dashed line 714.

In other aspects, the computing device 712 includes additional features or functionality. For example, the computing device 712 may include additional storage such as removable storage or non-removable storage, including, but not limited to, magnetic storage, optical storage, etc. Such additional storage is illustrated in FIG. 7 by storage 720. In one aspect, computer readable instructions to implement one aspect provided herein are in storage 720. Storage 720 may store other computer readable instructions to implement an operating system, an application program, etc. Computer readable instructions may be loaded in memory 718 for execution by the at least one processing unit 716, for example.

The term “computer readable media” as used herein includes computer storage media. Computer storage media includes volatile and nonvolatile, removable, and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 712. Any such computer storage media is part of the computing device 712.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 712 includes input device(s) 724 such as keyboard, mouse, pen, voice input device, touch input device, infrared cameras, video input devices, or any other input device. Output device(s) 722 such as one or more displays, speakers, printers, or any other output device may be included with the computing device 712. Input device(s) 724 and output device(s) 722 may be connected to the computing device 712 via a wired connection, wireless connection, or any combination thereof. In one aspect, an input device or an output device from another computing device may be used as input device(s) 724 or output device(s) 722 for the computing device 712. The computing device 712 may include communication connection(s) 726 to facilitate communications with one or more other devices 730, such as through network 728, for example.

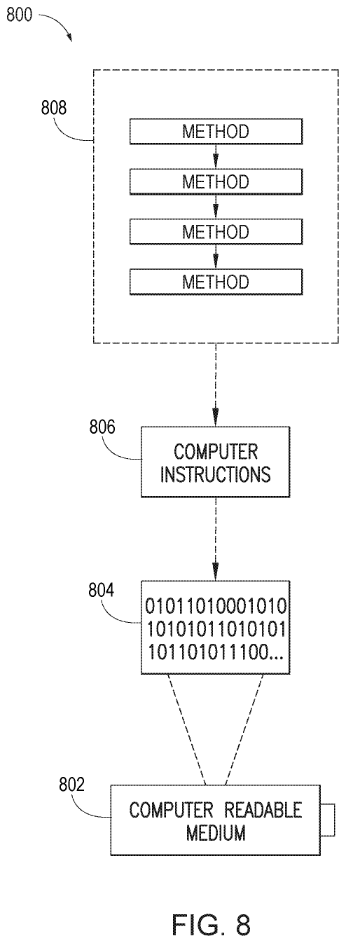

Still another aspect involves a computer-readable medium including processor-executable instructions configured to implement one aspect of the techniques presented herein. An aspect of a computer-readable medium or a computer-readable device devised in these ways is illustrated in FIG. 8, wherein an implementation 800 includes a computer-readable medium 802, such as a CD-R, DVD-R, flash drive, a platter of a hard disk drive, etc., on which is encoded computer-readable data 804. This encoded computer-readable data 804, such as binary data including a plurality of zero's and one's as shown in 804, in turn includes a set of processor-executable computer instructions 806 configured to operate according to one or more of the principles set forth herein. In this implementation 800, the processor-executable computer instructions 806 may be configured to perform a method 808, such as the computer-implemented method 200 for orthophoto segmentation of FIG. 2. In another aspect, the processor-executable computer instructions 806 may be configured to implement a system, such as the system 100 for orthophoto segmentation of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for orthophoto segmentation, comprising:
a memory storing one or more instructions; and
a processor executing one or more of the instructions stored on the memory to perform:
cropping an orthophoto into a set of segments;
segmenting each segment of the set of segments using a segmentation model to generate a set of segmentation masks for each segment of the set of segments; and
unionizing segments that are neighboring segments from the set of segments based on the set of segmentation masks for each segment to generate a finely-segmented (FS) terrain map.

2. The system for orthophoto segmentation of claim 1, wherein a first segment of the set of segments at least partially overlaps a second segment of the set of segments.

3. The system for orthophoto segmentation of claim 1, wherein the processor generates a coarsely-segmented (CS) terrain map without cropping the orthophoto based on a second segmentation model.

4. The system for orthophoto segmentation of claim 3, wherein the processor generates a combined terrain map based on the FS terrain map and the CS terrain map.

5. The system for orthophoto segmentation of claim 4, wherein the processor assigns a cost to each segmentation mask of the combined terrain map.

6. The system for orthophoto segmentation of claim 4, wherein the processor performs path planning for a vehicle based on the combined terrain map.

7. The system for orthophoto segmentation of claim 1, wherein the processor identifies one or more objects from the FS terrain map using on a neural network.

8. The system for orthophoto segmentation of claim 1, wherein the processor performs unionizing the segments based on an intersection of union (IoU) of the set of segmentation masks for each segment.

9. The system for orthophoto segmentation of claim 1, wherein the processor performs unionizing the segments based on a maximum intersection of union (IoM) of the set of segmentation masks for each segment.

10. The system for orthophoto segmentation of claim 1, wherein the segmentation model used to segment each segment of the set of segments is a Segment Anything Model (SAM).

11. A computer-implemented method for orthophoto segmentation, comprising:
cropping an orthophoto into a set of segments;
segmenting each segment of the set of segments using a segmentation model to generate a set of segmentation masks for each segment of the set of segments; and
unionizing segments that are neighboring segments from the set of segments based on the set of segmentation masks for each segment to generate a finely segmented (FS) terrain map.

12. The computer-implemented method for orthophoto segmentation of claim 11, wherein a first segment of the set of segments at least partially overlaps a second segment of the set of segments.

13. The computer-implemented method for orthophoto segmentation of claim 11, comprising generating a coarsely-segmented (CS) terrain map without cropping the orthophoto based on a second segmentation model.

14. The computer-implemented method for orthophoto segmentation of claim 13, comprising generating a combined terrain map based on the FS terrain map and the CS terrain map.

15. The computer-implemented method for orthophoto segmentation of claim 14, comprising assigning a cost to each segmentation mask of the combined terrain map.

16. The computer-implemented method for orthophoto segmentation of claim 14, comprising performing path planning for a vehicle based on the combined terrain map.

17. The computer-implemented method for orthophoto segmentation of claim 11, comprising identifying one or more objects from the FS terrain map using on a neural network.

18. The computer-implemented method for orthophoto segmentation of claim 11, wherein the unionizing the segments is based on an intersection of union (IoU) and a maximum intersection of union (IoM) of the set of segmentation masks for each segment.

19. The computer-implemented method for orthophoto segmentation of claim 11, wherein the segmentation model used to segment each segment of the set of segments is a Segment Anything Model (SAM).

20. A system for orthophoto segmentation, comprising:
a memory storing one or more instructions; and
a processor executing one or more of the instructions stored on the memory to perform:
cropping an orthophoto into a set of segments;
segmenting each segment of the set of segments using a segmentation model to generate a set of segmentation masks for each segment of the set of segments;
unionizing segments that are neighboring segments from the set of segments based on the set of segmentation masks for each segment; and
generating a finely segmented (FS) terrain map based on the unionized segments.
